(19) United States
(12) Patent Application Publication
(10) Pub. No.: US 2011/0020599 A1
(43) Pub. Date: Jan. 27, 2011

(54) PERFORATED-CORE COMPOSITE PANEL, DEVICE AND METHOD FORMANUFACTURING SUCH A PANEL

(76) Inventors: Guy Le Roy, Paris (FR); Gilles Romigou, Lanvern (FR)

Correspondence Address: GREER, BURNS & CRAIN, 300 S WACKER DR, 25TH FLOOR, CHICAGO, IL, 60606, US

(21) Appl. No.: 12/935,160

(22) PCT Filed: Mar. 24, 2009
(86) PCT No.: PCT/FR09/50504

§ 371 Date: Sep. 28, 2010

(30) Foreign Application Priority Data
Mar. 31, 2008 (FR) 0852111

(51) Int. Cl. B32B 5/02; B32B 5/28; D04H 13/00

(52) U.S. Cl. 428/134; 428/138; 428/172; 428/139; 156/148; 28/104

(57) ABSTRACT

The invention relates to a composite panel (1), comprising two fibrous plies (21) and a core (3) placed in the intervening volume between the plies (21) and connected together by a solidified binding material (22), characterized in that openings (6) are made in the core (3), via at least one of its faces (31; 32), so as to exclusively receive solidified binding material (22). The invention also relates to a device and to a method for manufacturing such a composite panel. Use for inexpensively producing particularly strong composite panels, with the possibility of having a very wide range of options as regards the constituents of the core and of the fibrous plies.

The present invention relates to a composite panel.

The present invention also relates to a device for making such a panel.

The present invention also relates to a method of producing the composite panel.

So-called “sandwich” composite panels, which are well known, comprise two skins that are resistant to various stresses, placed on each side of a web, at least the main components of which are preformed geometrical solids, typically made from foam or felt. The skins comprise a fibrous reinforcement impregnated with a resin that confers on these skins a certain intrinsic rigidity as well as a bond with the web.

These panels are very widespread in applications in which walls must be produced that are rigid, light, durable, impact resistant, etc.

A particular function of the web is to keep a substantially fixed distance between the two skins. Consequently, the panel can only bend to the extent that the radially outer skin (relative to the bending axis) is capable of stretching, and the radially inner skin is capable of contracting. As the skins have a low ability to stretch and contract, the panel is stiff in bending.

However, the known panels are subject to the risk of so-called “delamination” consisting in that, in particular under bending stress, at least one of the skins becomes detached from the web. In this case, the mechanical characteristics of the panel deteriorate unacceptably.

In order to overcome this difficulty, the creation of a mechanical bond between each skin and the web has been proposed. For example the production of a seam between the fibrous reinforcement of the skin and the web has been proposed, before the step of impregnation of the skins with the resin. Such methods are effective to some extent, but they require additional operations with complex machines that are relatively slow and considerably increase the investment in industrial plant and the time required for manufacturing a panel. Panels reinforced in this way are therefore expensive.

From the Applicant's document FR 2 881 442, a composite panel is known, comprising two fibrous skins and a web placed in the inner volume between the skins and bonded to the latter by a solidified resin, in which bonding fibres originating from the skins have been rammed perpendicularly into the inner volume between the skins, the rammed fibres being grouped in tufts situated at sites where resin is also present. Without calling into question the benefit of such a panel, it has been noted that the structure and the method of manufacturing such a panel can also be modified, in particular in the interests of simplification and reduced cost, without thereby reducing appreciably the mechanical properties of the panel, and in particular its satisfactory resistance to the risks of delamination.

The purpose of the present invention is thus to propose a composite panel that is very economical and reliably provides improved mechanical characteristics.

To this end, a subject of the invention is a composite panel, comprising two fibrous layers, and a web placed in the inner volume between the layers and bonded thereto by a solidified bonding material, characterized in that recesses are formed in the web, through at least one of its faces, in order to receive exclusively solidified bonding material.

The recesses are only intended to receive bonding material. The solidified bonding material behaves so as to root each skin in the web, the skin being made up of a fibrous layer impregnated with bonding material. This rooting effectively opposes the delamination of the panel.

Industrial methods based on a well known principle make it possible according to the invention to produce recesses at speeds that cause practically no slowing of the composite panel production line. Such an industrial method is typically needlepunching.

Moreover, the invention makes it possible to reinforce the bond between the web and each skin as desired. It is merely necessary to choose a density of recesses, typically a density of needlepunching (number of strikes per unit of surface area of the panel) appropriate to the results sought. The density can be uniform or conversely different for different areas of the panel, according to the stresses expected in service for each area and/or according to local characteristics of the panel, for example the presence of inserts or cavities in certain areas of the web.

The bonding material can be a resin, optionally a foamed resin, a binder, etc., with which the panel is impregnated after formation of the recesses and the process of coating each face of the web with the fibrous skins. The bonding material solidifies during polymerization and ensures the consolidation of the skins as well as the stratification of the panel.

The bonding material impregnates the fibre layers and is received in at least one portion of the recesses by injection and/or infusion.

At least one portion of the recesses receiving bonding material is formed in at least one constituent of the web, in particular by needlepunching, perforation, or punching, such that each recess has a profile extending along an axis and a penetration length.

It is possible to form recesses over only a portion of the thickness of the inner volume. This is advantageous for very thick panels. It is thus possible to implement the invention without the need for a needlepunching stroke as large as the thickness of the panel. This is also advantageous for implanting bonding material in recesses of the web that extend over only a portion of the thickness of the web. But in many applications, it is preferred for the bonding material to form bridges linking the two layers together. To this end, it can be arranged for the bonding material impregnating a layer to reach and be implanted in the fibrous reinforcement of the other layer in order to produce a bond between the two layers. In this case, recesses are formed through each face of the web in such a way as to be connected to each other in an inner area of the latter. Also, the bonding material introduced into a recess can reach the bonding material introduced into the other recess and join with the latter during the solidification. By migrating through the recesses, the bonding material provides a bond between the outer fibrous skins.

At least one portion of the recesses, called first recesses, formed through a face of the web are associated in pairs with corresponding recesses, called second recesses, formed through the other face of the web, such that the recesses in the same pair are substantially parallel and have a centre distance of 0 to 0.7 mm.

The sum of the penetration lengths of the recesses in the same pair is greater than the local thickness of the web, each of the penetration lengths of the first and second recesses in the same pair being less than the local thickness of the web.

At least one portion of the recesses includes an axis of penetration substantially perpendicular to the panel.

At least one portion of the recesses includes an axis of penetration that is inclined with respect to the panel.

The recesses have a diameter generally comprised between 0.5 mm and 2.67 mm. These diameters depend on the fineness of the needles, the limit of which is 2.67 mm in needlepunching.

Preferably, the recesses are located along geometrical patterns such as rows, squares and staggered points. The nature of these patterns, as well as the dimension of the elementary pattern, allows for certain areas of the panel, and/or the whole of the panel, to be more or less reinforced.

At least one of the faces of the web can be formed in a non-flat manner.

It is also possible to produce a panel comprising at least two superimposed webs optionally with an inner layer, in particular fibrous, inserted between the two webs. In this case the recesses can be formed in each of the two webs, so that the bonding materials passing through each of the two webs are situated substantially in the same axis, or are offset in relation to each other.

A subject of the invention is also a device for producing a panel comprising means of conveying a web comprising at least one preformed element to a needlepunching unit, at least one needlepunching unit for forming recesses on the web through at least one of its faces.

A subject of the invention is also a method of producing a composite panel having the characteristics previously referred to, in which a recess is formed by needlepunching directly in the web through at least one of its faces.

Before needlepunching, it is also possible to form at least one face of the web, in particular by milling or cutting. The forming can consist either of giving this face of the web the form envisaged for the corresponding face of the finished product, or preparing, for example in the form of a groove or channel, deformation areas that will then make it possible, by moulding during the impregnation, to give the panel a non-flat general form.

In the method according to the invention, first recesses are formed through a face of the web and second recesses through the other face of the web, the first and second recesses having profiles extending along substantially parallel axes, and being associated in pairs so that the recesses in the same pair have a centre distance of 0 to 0.7 mm.

The recesses in the same pair are formed by needle strikes from a corresponding pair of needles, the penetration of which into the web is such that the sum of the penetration lengths of the needles in the same pair is greater than the thickness of the web, each of the penetration lengths of the needles in the same pair being less than the local thickness of the web.

The needle strikes of the same pair can be substantially simultaneous or not simultaneous.

It will be noted that the needles of a board, situated on the same side of the panel must preferably not penetrate the entire thickness of the web as the ramming causes the material pushed by the needles to be forced back. The quantity of material, like a slub, would burst the opposite surface, producing a small crater, leading to a surface defect on the finished product and an increase in the volume of the bonding material required, equally detrimental to the finished product. The penetration of two needle boards, on either side of the web, which simultaneously penetrate into the web through its two opposite faces gives the following advantages:

balancing the penetration forces, as some high-density webs (more than 100 kg/m3), require forces of the order of several kilos per needle. This force requires bending-resistant needles, thus with a modified cross-section.

the need to use two needle boards avoids cantilever forces on the appliances.

the reduced penetration of the needles, in order to avoid the creation of craters when the slub exits, requires the clearing of the recess in order to facilitate the passage of the bonding material on either side of the web. This passage is implemented by the penetration of needles that are not opposite each other and only penetrate over a distance of 70 to 90% of the thickness of the web. Their position on the respective boards is combined with a precision feed of the web at a pitch of approximately 0.1 mm between the needle boards, allowing for the production of two recesses through the opposite faces of the web that are offset with a centre distance of a few tens of millimetres, typically from 0 to 0.7 mm as referred to previously.

The needle strikes can be carried out in a substantially perpendicular direction or in a variant, in a direction inclined in relation to the latter.

An arrangement of needles and/or a feed pitch between successive needle strikes is used in order to produce a pattern of recesses receiving the bonding material.

After needlepunching, the web is placed between two fibrous layers, in particular in a mould, in order to cover the two faces of the web with said layers and the layers are impregnated with bonding material in order to form the outer skins of the panel.

Between the two skins, bridges of bonding material are formed, linking the two skins.

Other advantages and characteristics of the invention will become apparent on examination of the following description of embodiments which are in no way limitative, and the attached diagrams, in which:

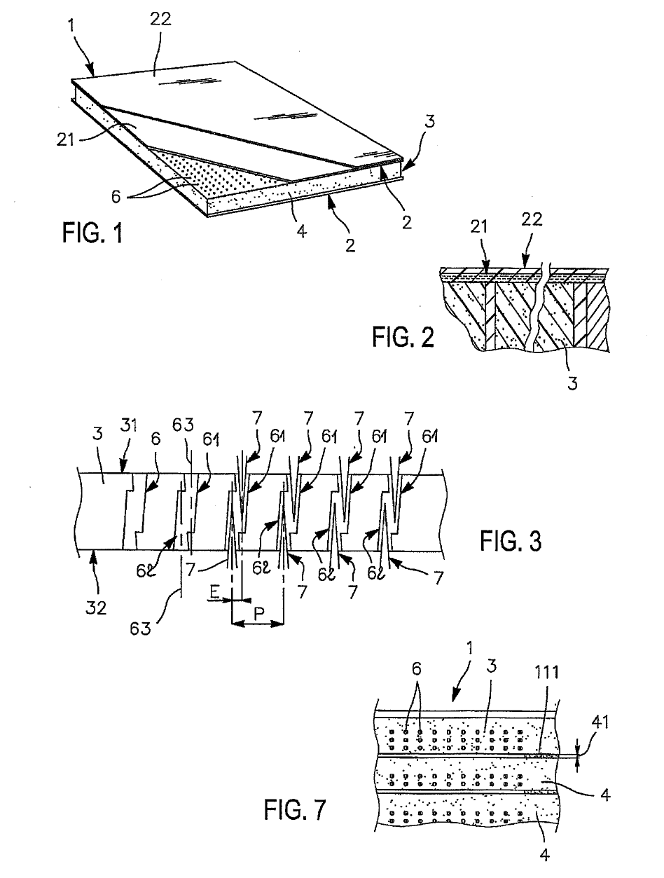

FIG. 1 is a perspective view, with cutaway, of a panel according to the invention;

FIG. 2 shows a cross-section, on an enlarged scale, of a detail of the panel in FIG. 1, as two recesses receiving bonding material;

FIG. 3 is a partial longitudinal cross-sectional view of the panel in FIG. 1;

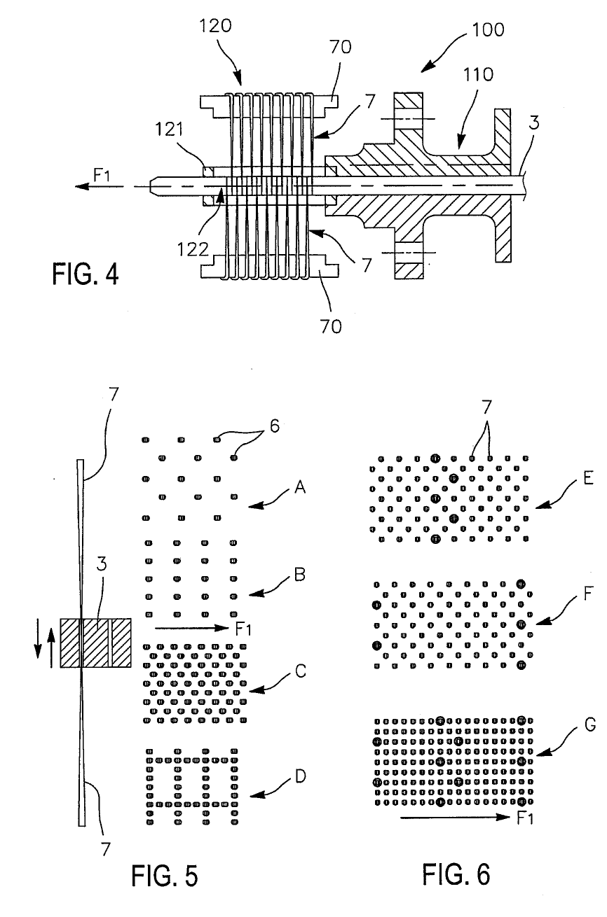

FIG. 4 is a longitudinal cross-sectional view of an appliance for a device for making a panel according to the invention;

FIG. 5 is a top view of a panel according to the invention, showing different recess patterns;

FIG. 6 is a view of the needle boards allowing recesses to be formed in a panel according to the invention, showing needle distributions in action in order to produce a staggered pattern according to FIG. 5; and

FIG. 7 is a partial top view of an appliance according to FIG. 3, during production.

By the term “panel” is meant according to the invention a composite material having a relatively small thickness dimension in relation to two other straight or curved dimensions such as a length and a width. In particular, the term “panel” does not limit the object in question to a solid object, nor to an object having a constant thickness.

In the example shown in FIG. 1, the panel 1 comprises two skins 2 extending in parallel planes, between them defining an inner volume occupied by a web 3. In the example shown, the web 3 is made up of a foam slab 4. The skins 2 are assembled onto the web 3 during moulding in order to form a sandwich.

Each skin 2 comprises a fibre layer 21, which is a bi- or multidirectional weave made of an inorganic or plant material. The layer is used as surface reinforcement. The layer 21 is immersed in a bonding material such as a resin 22 so as to absorb a quantity thereof. In FIG. 1, the resin 22 is diagrammatically shown superimposed on the fibrous layer 21. In practice, as shown in FIG. 2, the resin 22 impregnates the fibres 21, thus producing a solidification of the fibre-resin assembly as well as firmly attaching this assembly to the surface of the web 3.

According to the invention, before the outer faces of the web 3 are covered with the fibre layers 21, recesses 6 are formed in the web 3 through its outer faces. These recesses 6 are produced in at least one constituent of the web 3 such as a slab 4 mentioned above. The recesses 6 are exclusively intended to receive bonding material during a later step of the method.

With reference to FIG. 3, the recesses 6 are formed by needlepunching, perforation or punching, using boards 70 with needles 7 placed on each side of the web 3 that perforate the web through each of its faces 31, 32. The recesses 6 have an elongated profile along a longitudinal axis 63, which extends over a certain penetration length L towards the inside of the web 3. In the context of needlepunching, the terms “perforation” or “microperforation” can also be used instead of the term “recess” by a person skilled in the art.

According to the invention, a portion of the recesses, which will be called recesses 61 in that they are formed through a first face 31 of the web 3 are associated in pairs with second recesses 62, formed through the second face 32 of the web 3, opposite the first, so as to form pairs of recesses.

According to the invention, the first 61 and second 62 recesses in the same pair are substantially parallel and have axes offset by a centre distance E of the order of 0 to 0.7 mm. The needles 7 generating these recesses are engaged simultaneously in the web 3, through each of its faces.

Advantageously, the sum of the penetration lengths L (in the geometrical sense) of the recesses 61, 62 in the same pair is greater than the local thickness. Moreover, each of the penetration lengths L of the first 61 and second 62 recesses in the same pair is less than the local thickness of the web 3. Thus the first 61 and second 62 recesses have an overlap area in the direction of the thickness of the web 3. The recesses have a diameter that can range from approximately 0.5 to the maximum gauge that can be used in needlepunching, i.e. a gauge sized 2.67 mm if necessary. The recesses in the same pair meet in order to create a duct opening onto the two faces of the web 3. Thus, the recesses 61 and 62 form wells for the bonding material 22 when their skins 2 are subsequently impregnated. The bonding material 22 thus forms bridges linking the two skins 2.

In a variant embodiment of the invention, shown in FIG. 3, the axes of penetration 63 of the recesses 6 are substantially perpendicular to the panel 1, i.e. to the planes of the outer faces 31, 32 of the web 3. The bonding material 22 introduced into these recesses thus adopts a longitudinal form perpendicular to the plane of the panel 1.

In another variant embodiment, not shown, the recesses 6 have axes of penetration inclined with respect to the panel 1, in order to orient the bonding material 22 in this same direction.

It will be noted that the recesses 6 can be grouped in individual or linear recesses. A staggered arrangement can be envisaged between different individual recesses or rows of recesses. Generally, the patterns and the density chosen can be adapted as desired in each panel and also, in a particular panel, in each given region of the panel. The density can vary between approximately 40 and 500 recesses/dm². Differentiated longitudinal areas can be created. The creation of differentiated transverse areas can even be envisaged, for example by modulating the speed of feeding a panel through the manufacturing device that will be described below. For the density range stated previously, the distance P between two successive recesses 6 in the direction of movement of the panel 1 is of the order of approximately 4 to 25 mm, and corresponds to the feed pitch, a multiple or a division of the feed pitch per penetration cycle.

When the recesses 6 have been formed in the web 3 according to the desired arrangement and density, it is covered with two fibrous skins 2 placed next to each of these two faces, during a moulding operation, in order to form a sandwich.

The skins 2 are then impregnated with the bonding material 22. The effect of the impregnation is to make the bonding material penetrate into the web 3 along the recesses 6. The penetration takes place not only in the recesses 6 but also in any grooves, channels, gaps, wells, etc., that might be present on the surface of the web.

The bonding material 22 has the effect of closely bonding the neighbouring materials, namely the inner walls of the web 3 and the regions of the skins 2 overhanging the recesses 6. Thus the web 3 and each skin 2 are attached together, resulting in a particularly high resistance to delamination of the panel. Moreover, in the case of through recesses and bonding material 22 forming bridges between the two skins 2, the two skins 2 are also attached to each other.

A description will now be given, with reference to FIG. 4, of an appliance 100 that can be used in a device for making a panel 1 according to the invention. The appliance 100 comprises a guide 110 for conveying the web 3 in a feed movement towards the left-hand side in FIG. 4 (arrow F1).

The production appliance 100 shown in FIG. 4 also comprises a needlepunching appliance 120 intended to form recesses 6 in the web 3 by perforating the latter through each of these two faces. The needlepunching appliance 120 itself comprises:

two strippers 121, between them defining a needlepunching path 122 constituting the continuation of the path through the guide 110;

two needle boards 70 situated on each side, respectively, of the needlepunching path 122, and holding needles 7 orientated, in the example shown, perpendicularly to the plane of the path 122, the points of the needles 7 are capable of penetrating into the needlepunching path 122 through slots formed between plates (not shown) constituting the strippers 121 in the area in which the needles 7 are located.

When the appliance 100 is installed in a production machine, each needle board 70 is fixed to a means of actuation in a reciprocating motion perpendicular to the plane of the needlepunching path 122 so that the points of the needles 7 penetrate into the needlepunching path 122 and then leave it. The feed of the web 3 along the arrow F1 is synchronized with the movement of the needles 7 so that the web is fed when the needles 7 are disengaged from the needlepunching path 122 and the feed of the web is stopped when the needles 7 are projecting into the needlepunching path 122. In the example shown, the needles 7 situated on one side of the needlepunching path 122 are offset in relation to the needles 7 situated on the other side, making it possible to synchronize the two needle boards 70 so that all the needles 7 are simultaneously engaged in the needlepunching path 122 and are simultaneously disengaged from it in order to allow for the feeding of the web 3.

In FIG. 7, the panel 1 is shown in a top view, during production, on exit from the guide 110 and at the level of the needlepunching appliance 120. The web 3 comprises recesses 6 that have just been formed. The web 3 of the panel 1 during production can be constituted by relatively narrow foam slabs 4 in the form of strips, separated by guide walls 111 that keep a certain gap 41 between the slabs 4. The guide walls 111 are fixed in the insertion guide 110 and end just upstream of the needles 7.

Generally, the arrangement of the needles 7 on the boards 70, the strike rate of the needles 7 and the feed pitch of the product along the arrow F1 are chosen in combination in order to obtain the desired pattern of recesses 6.

FIG. 5 shows different recess patterns that can be formed on a web 3 of a panel 1 according to the invention. The arrow F1 shows the direction of the sequential feed of the web between the needle boards that takes place when the needles are outside the web 3. Pattern A is a staggered arrangement of the recesses 6. Pattern B is an arrangement of the recesses in transverse rows, in relation to the direction of feed of the web 3. Pattern C is also a staggered arrangement of the recesses 6 with a greater density than pattern A. The pattern D is a grid arrangement with longitudinal and transverse rows in relation to the direction of feed of the web 3.

FIG. 6 also shows, by way of example, the arrangement of the needles 7 on each upper and lower board 70, respectively shown in E and F, with those needles that penetrate into the web 3 in order to form the staggered pattern A in FIG. 5 circled in bold. The superposition of the sites of the needles of the upper and lower boards 70 is shown in G. The arrow F1 still shows the direction of sequential feed of the web between the needle boards, when the needles are outside the web 3. As the penetration of the needles 7 of the upper and lower boards 70 is simultaneous, it will be noted that the distribution of the implanted needles of the two boards provides a balance of forces, avoiding any leverage on the web 3. The web 3 is only subjected to compressive forces in the direction perpendicular to its plane.

After leaving the needlepunching appliance 120, the semi-finished product is cut into panel units, by transverse cutting with a known cutting appliance, not shown. In a moulding station, the cut panels are inserted into a mould where the fibrous layers are placed, into which the bonding material such as resin is injected. This step, in itself conventional, is also not shown, as it is known in the manufacture of composite panels known as “sandwich” panels. The mould can be flat in order to produce a flat panel, or conversely not flat in order to simultaneously deform the flat semi-finished product into a finished panel having a desired non-flat form.

The fibre layers 21 can originate from reels of pre-strengthened mat. These fibre layers can also originate from filaments cut up into cut fibres and scattered on the web before its introduction into the mould.

Of course, the invention is not limited to the examples described and shown.

The web can itself be at least partially fibrous.

The dimensions of a panel according to the invention can be very freely chosen depending on the fields of application which can be: motor vehicle interior trim, bodywork panels for utility vehicles, bodywork parts or chassis platforms for motor vehicles, panels for construction, for furniture, insulating panels, roofing panels, panels for the interior trim of railway vehicles, aeroplanes or boats, door leaves, etc. Non-limitatively, thicknesses from 10 mm to 80 mm can be produced. The plastic materials used can be chosen from thermoplastic or thermosetting materials. The width of the panels, relative to the direction F1, can be adapted to commercial requirements, without thereby altering the principle.

In all of the examples shown, the components of the web have a stable form on entering the manufacturing device.

However, the web can have a certain pliability or flexibility, which then allows for moulding with a complex shape or significant deformation, for example for producing parts for shipbuilding, motor vehicles or elements having a similarly complex shape.

Furthermore, a panel is shown having a web 3 provided with substantially flat and parallel outer faces. Without exceeding the scope of the invention, the faces of the web can be non-flat and can for example have a form that is generally corrugated, convex, concave, etc.

Moreover, the panel can comprise at least two superimposed web units, separated by an inner skin.

1. Composite panel (1), comprising two fibrous layers (21), and a web (3) placed in the inner volume between the layers (21) and bonded to the latter by a solidified bonding material (22), characterized in that recesses (6) are formed in the web (3), through at least the one of its faces (31; 32), in order to receive exclusively solidified bonding material (22).

2. Panel according to claim 1, characterized in that the bonding material (22) impregnates the layers (21) and is received in at least one portion of the recesses (6) by injection and/or infusion.

3. Panel according to claim 1 or 2, characterized in that at least one portion of the recesses (6) receiving the bonding material (22) is formed in at least one constituent of the web (3), in particular by needlepunching, perforation, or punching, so that each recess (6) has a profile extending along an axis (63) and a penetration length (L).

4. Panel according to one of claims 1 to 3, characterized in that solidified bonding material (22) forms bridges bonding the two layers (21) together.

5. Panel according to one of claims 1 to 4, characterized in that at least one portion of the recesses, called first recesses (61), formed through a face (31) of the web (3) are associated in pairs with corresponding recesses, called second recesses (62), formed through the other face (32) of the web (3), so that the recesses in the same pair are substantially parallel and have a centre distance of 0 to 0.7 mm.

6. Panel according to claim 5, characterized in that the sum of the penetration lengths (L) of the recesses (6) in the same pair is greater than the local thickness of the web (3), each of the penetration lengths of the first (61) and second (62) recesses in the same pair being less than the local thickness of the web (3).

7. Panel according to one of claims 4 to 6, characterized in that at least one portion of the recesses (6) comprises an axis (63) of penetration substantially perpendicular to the panel (1).

8. Panel according to one of claims 4 to 6, characterized in that at least a portion of the recesses comprises an axis of penetration inclined in relation to the panel (1).

9. Panel according to one of claims 1 to 6, characterized in that the recesses (6) have a diameter comprised between 0.5 mm and 2.67 mm.

10. Panel according to one of claims 1 to 9, characterized in that the recesses (6) receiving the solidified bonding material (7) are located along geometrical patterns such as rows, squares and staggered points.

11. Panel according to one of claims 1 to 10, characterized in that at least one (31; 32) of the faces of the web (3) is formed in a non-flat manner.

12. Panel according to one of claims 1 to 11, characterized in that it comprises at least two superimposed web units, in particular with an inner layer interposed.

13. Device for making a panel according to one of claims 1 to 12, characterized in that it comprises:
means of conveying (110) a web (3) comprising at least one preformed element (4) to a needlepunching unit (120),
at least one needlepunching unit (120) for forming recesses (6) on the web (3) through at least one of its faces (31; 32).

14. Method of producing a composite panel according to one of claims 1 to 12, characterized in that recesses (6) are formed by needlepunching directly in the web (3) through at least one of its faces (31; 32).

15. Method according to claim 14, characterized in that first recesses (61) are formed through a face (31) of the web (3) and second recesses (62) through the other face (32) of the web (3), the first (61) and second (62) recesses having profiles extending along substantially parallel axes, and being associated in pairs so that the recesses (6) in the same pair have a centre distance of 0 to 0.7 mm.

16. Method according to claim 15, characterized in that the recesses (6) in the same pair are formed by needle strikes (7) of a corresponding pair, the penetration into the web (3) of which is such that the sum of the penetration lengths (L) of the needles (7) in the same pair is greater than the thickness of the web (3), each of the penetration lengths (L) of the needles (7) in the same pair being less than the local thickness of the web (3).

17. Method according to claim 15 or 16, characterized in that the needle strikes (7) of the same pair are substantially simultaneous.

18. Method according to claim 15 or 16, characterized in that the needle strikes (7) of the same pair are not simultaneous.

19. Method according to one of claims 15 to 18, characterized in that the needle strikes (7) are carried out in a direction substantially perpendicular to the panel (1).

20. Method according to one of claims 15 to 18, characterized in that the needle strikes (7) are carried out in a direction inclined in relation to the panel (1).

21. Method according to one of claims 15 to 20, characterized in that an arrangement of needles (7) and/or a feed pitch between successive strikes of the needles (7) is used in order to produce a pattern of recesses (6) receiving bonding material (22).

22. Method according to one of claims 15 to 21, characterized in that after needlepunching the web (3) is placed between two fibrous layers (21), in particular in a mould, and the layers (21) are impregnated with bonding material (22).

23. Method according to claim 22, characterized in that bridges of bonding material (22) are formed between the two layers (21), linking the two layers (21).
